(19) United States
(12) Patent Application Publication
(10) Pub. No.: US 2025/0061651 A1
(43) Pub. Date: Feb. 20, 2025

(54) INFORMATION PROCESSING DEVICE, INFORMATION PROCESSING METHOD, AND PROGRAM

(71) Applicant: SONY GROUP CORPORATION, TOKYO (JP)

(72) Inventor: YOSHIYUKI TAKAO, TOKYO (JP)

(21) Appl. No.: 18/715,800

(22) PCT Filed: Nov. 25, 2022
(86) PCT No.: PCT/JP2022/043455

§ 371 Date: Jun. 3, 2024

(30) Foreign Application Priority Data
Dec. 9, 2021 (JP) 2021-200277

(51) Int. Cl. G06T 17/00; G06T 7/70; G06V 10/25

(52) U.S. Cl. CPC G06T 17/00; G06T 7/70; G06V 10/25; G06T 2207/20084; G06T 2207/30196; G06V 2201/07

(57) ABSTRACT

The present technology relates to an information processing device, an information processing method, and a program that makes it possible to appropriately generate a 3D model of a modeling target on the basis of captured images obtained by capturing the modeling target from multiple viewpoints. 3D shape data representing a 3D shape of a modeling target, which is a target for generating a 3D model, is generated on the basis of a plurality of captured images obtained by capturing the modeling target from different viewpoint positions, and 3D shape data of a missing section of the modeling target is interpolated, the missing section being missing in the 3D shape data.

### TECHNICAL FIELD

The present technology relates to an information processing device, an information processing method, and a program, and more particularly, to an information processing device, an information processing method, and a program capable of appropriately generating a 3D model of a modeling target from a captured image obtained by capturing the modeling target from multiple viewpoints in a volumetric capture technology or the like.

### BACKGROUND ART

Patent Document 1 discloses a technology of performing rolling shutter distortion correction and image synthesis or the like in a multi-view imaging device using a rolling shutter type image sensor.

### CITATION LIST

### Patent Document

Patent Document 1: Japanese Patent Application Laid-Open No. 2013-120435

### SUMMARY OF THE INVENTION

### Problems to be Solved by the Invention

In a case where a 3D model of a modeling target is generated from a captured image obtained by capturing the modeling target from multiple viewpoints in a volumetric capture technology or the like, if a captured image captured by a rolling shutter type is used, the 3D model of the modeling target may not be appropriately generated due to a shift in exposure timing for each scan line.

The present technology has been made in view of such a situation, and makes it possible to appropriately generate a 3D model of a modeling target on the basis of captured images obtained by capturing the modeling target from multiple viewpoints.

### Solutions to Problems

An information processing device or a program of the present technology is an information processing device including: a 3D shape data generation unit configured to generate 3D shape data representing a 3D shape of a modeling target, which is a target for generating a 3D model, on the basis of a plurality of captured images obtained by capturing the modeling target from different viewpoint positions; and an interpolation unit configured to interpolate 3D shape data of a missing section of the modeling target, the missing section being missing in 3D shape data generated by the 3D shape data generation unit, or a program causing a computer to function as such an information processing device.

An information processing method of the present technology is an information processing method performed by an information processing device including a 3D shape data generation unit and an interpolation unit, the method including: generating, by the 3D shape data generation unit, 3D shape data representing a 3D shape of a modeling target, which is a target for generating a 3D model, on the basis of a plurality of captured images obtained by capturing the modeling target from different viewpoint positions; and interpolating, by the interpolation unit, 3D shape data of a missing section of the modeling target, the missing section being missing in the 3D shape data.

With the information processing device, the information processing method, and the program of the present technology, 3D shape data representing a 3D shape of a modeling target, which is a target for generating a 3D model, is generated on the basis of a plurality of captured images obtained by capturing the modeling target from different viewpoint positions, and 3D shape data of a missing section of the modeling target is interpolated, the missing section being missing in the 3D shape data.

### BRIEF DESCRIPTION OF DRAWINGS

FIG. 1 is a block diagram illustrating an outline of an information processing system to which the present technology is applied.

FIG. 2 is a diagram illustrating an arrangement example of imaging cameras that capture a subject.

FIG. 3 is a flowchart illustrating an example of a processing flow of the information processing system.

FIG. 4 is a diagram for explaining a problem caused by use of a rolling shutter type imaging camera.

FIG. 5 is a diagram exemplifying an image captured by one imaging camera (first camera) among imaging cameras of a plurality of viewpoints.

FIG. 6 is a diagram exemplifying an image captured by one imaging camera (second camera) among the imaging cameras of a plurality of viewpoints.

FIG. 7 is a diagram exemplifying an image captured by one imaging camera (third camera) among the imaging cameras of a plurality of viewpoints.

FIG. 8 is a diagram exemplifying 3D shape data generated from images captured by a plurality of rolling shutter type imaging cameras (of a plurality of viewpoints).

FIG. 9 is a diagram exemplifying an image rendered on the basis of the 3D shape data of FIG. 8.

FIG. 10 is a diagram showing the images shown in FIGS. 5 to 7 side by side.

FIG. 11 is a diagram for explaining part position estimation processing.

FIG. 12 is a diagram for explaining interpolation processing.

FIG. 13 is a diagram for explaining a case where a texture is generated from the image of FIG. 5.

FIG. 14 is a diagram exemplifying an image rendered using the texture generated from the image of FIG. 5.

FIG. 15 is a block diagram illustrating a configuration example of a 3D model generation unit.

FIG. 16 is a flowchart exemplifying a procedure of 3D model generation processing performed by the 3D model generation unit.

FIG. 17 is a diagram for explaining the 3D model generation processing in a case where a modeling target relates to soccer.

FIG. 18 is a diagram for explaining the 3D model generation processing in the case where a modeling target relates to soccer.

FIG. 19 is a diagram for explaining the 3D model generation processing in a case where a modeling target relates to soccer.

FIG. 20 is a block diagram illustrating a configuration example of hardware of a computer in a case where the computer executes a series of processing in accordance with a program.

### MODE FOR CARRYING OUT THE INVENTION

Hereinafter, an embodiment of the present technology will be described with reference to the drawings.

### <Embodiment of Information Processing System>

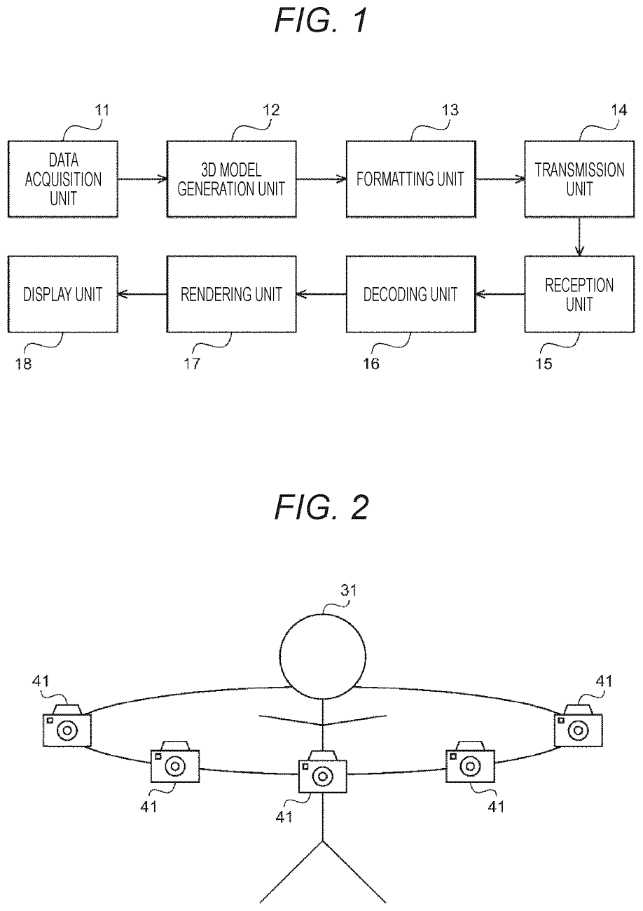

FIG. 1 illustrates an outline of an information processing system to which the present technology is applied. A data acquisition unit 11 acquires image data for generating a 3D model of a subject. For example, a) a plurality of viewpoint images (referred to as captured images or simply images) captured by a plurality of imaging devices 41 (of a plurality of viewpoints) (referred to as imaging cameras 41) disposed so as to surround a subject 31 as illustrated in FIG. 2 is acquired as image data. In this case, the plurality of viewpoint images is preferably images captured by the plurality of imaging cameras 41 in synchronization. Furthermore, the data acquisition unit 11 may acquire, for example, b) a plurality of viewpoint images obtained by capturing the subject 31 from a plurality of viewpoints by one imaging camera 41 as image data. Furthermore, the data acquisition unit 11 may acquire, for example, c) one captured image of the subject 31 as image data. In this case, a 3D model generation unit 12 as described later generates a 3D model using, for example, machine learning.

Note that the data acquisition unit 11 may perform calibration on the basis of the image data and acquire the internal parameters and the external parameters of each imaging camera 41. Furthermore, the data acquisition unit 11 may acquire, for example, a plurality of pieces of depth information indicating distances from viewpoints at a plurality of positions to the subject 31.

The 3D model generation unit 12 generates a model having three-dimensional information about the subject on the basis of image data for generating a 3D model of the subject 31. The 3D model generation unit 12 generates the 3D model of the subject by, for example, scraping the three-dimensional shape of the subject using images from a plurality of viewpoints (for example, silhouette images from the plurality of viewpoints) using what is referred to as a visual hull (visual-volume intersection method). In this case, the 3D model generation unit 12 can further deform the 3D model generated using the visual hull with high accuracy using the plurality of pieces of the depth information indicating distances from viewpoints at a plurality of positions to the subject 31. Furthermore, for example, the 3D model generation unit 12 may generate the 3D model of the subject 31 from one captured image of the subject 31. The 3D model generated by the 3D model generation unit 12 can also be referred to as a moving image of the 3D model by generating the 3D model in time series frame units. Furthermore, since the 3D model is generated using an image captured by the imaging camera 41, it can also be referred to as a live-action 3D model. The 3D model can represent shape information representing a face shape of the subject in the form of, for example, mesh data represented by connection between the vertex and the vertex, which is referred to as a polygon mesh. The method of representing the 3D model is not limited thereto, and the 3D model may be described by what is referred to as a point cloud representation method that represents the 3D model by position information about points.

Data of color information is also generated as a texture in association with the 3D shape data. For example, there are a case of a view independent texture in which colors are constant when viewed from any direction and a case of a view dependent texture in which colors change depending on a viewing direction.

A formatting unit 13 converts the data of the 3D model generated by the 3D model generation unit 12 into a format suitable for transmission and accumulation. For example, the 3D model generated by the 3D model generation unit 12 may be converted into a plurality of two-dimensional images by performing perspective projection from a plurality of directions. In this case, depth information that is two-dimensional depth images from a plurality of viewpoints may be generated using the 3D model. The depth information about the state of the two-dimensional image and the color information are compressed to output to a transmission unit 14. The depth information and the color information may be transmitted side by side as one image or may be transmitted as two separate images. In this case, since they are in the form of two-dimensional image data, they can be compressed using a two-dimensional compression technique such as advanced video coding (AVC).

Furthermore, for example, the data of the 3D model may be converted into a point cloud format. It may be output to the transmission unit 14 as the three-dimensional data. In this case, for example, a three-dimensional compression technique of Geometry-based Approach discussed in MPEG can be used.

The transmission unit 14 transmits the transmission data formed by the formatting unit 13 to a reception unit 15. The transmission unit 14 performs a series of processing of the data acquisition unit 11, the 3D model generation unit 12, and the formatting unit 13 offline, and then transmits the transmission data to the reception unit 15. Furthermore, the transmission unit 14 may transmit the transmission data generated from the series of processing described above to the reception unit 15 in real time.

The reception unit 15 receives the transmission data transmitted from the transmission unit 14.

A decoding unit 16 performs decoding processing on the transmission data received by the reception unit 15, and decodes the received transmission data into 3D model data (shape and texture data) necessary for display.

A rendering unit 17 performs rendering using the data of the 3D model decoded by the decoding unit 16. For example, it projects a mesh of a 3D model from a viewpoint of a camera that draws the mesh of the 3D model, and performs texture mapping to paste a texture representing a color or a pattern. The drawing at this time can be arbitrarily set and viewed from a free viewpoint regardless of the camera position at the time of capturing.

For example, the rendering unit 17 performs texture mapping to paste a texture representing the color, pattern, or texture of the mesh according to the position of the mesh of the 3D model. The texture mapping includes what is referred to as a view dependent method in which the viewing viewpoint of a user is considered and a view independent method in which the viewing viewpoint of a user is not considered. Since the view dependent method changes the texture to be pasted on the 3D model according to the position of the viewing viewpoint, there is an advantage that rendering of higher quality can be achieved than by the View Independent method. On the other hand, the view independent method does not consider the position of the viewing viewpoint, and thus there is an advantage that the processing amount is reduced as compared with the view dependent method. Note that the viewing viewpoint data is input from a display device to the rendering unit 17 after the display device detects a viewing point (region of interest) of the user. Furthermore, the rendering unit 17 may employ, for example, billboard rendering for rendering an object so that the object maintains a vertical posture with respect to the viewing viewpoint. For example, when rendering a plurality of objects, the rendering unit can render objects of low interest to a viewer by billboard and render other objects by another rendering method.

A display unit 18 displays a result of rendering by the rendering unit 17 on a display of the display device. The display device may be a 2D monitor or a 3D monitor, for example, a head mounted display, a spatial display, a cellular phone, a television, a PC, or the like.

An information processing system 1 in FIG. 1 illustrates a series of flow from the data acquisition unit 11 that acquires a captured image that is a material for generating content to the display unit 18 that controls the display device viewed by the user. However, it does not mean that all functional blocks are necessary for implementation of the present technology, and the present technology can be implemented for each functional block or a combination of a plurality of functional blocks. For example, in FIG. 1, the transmission unit 14 and the reception unit 15 are provided in order to illustrate a series of flow from an operation of creating content to an operation of viewing the content through distribution of content data, but in a case where the operations of content creation to viewing are performed by the same information processing device (for example, a personal computer), it is not necessary to include the formatting unit 13, the transmission unit 14, the reception unit 15, or the decoding unit 16.

When the present information processing system 1 is implemented, the same implementer may implement all of them, or different implementers may implement respective functional blocks. As an example, a business operator A generates 3D content through the data acquisition unit 11, the 3D model generation unit 12, and the formatting unit 13. Then, it is conceivable that the 3D content is distributed through the transmission unit 14 (platform) of a business operator B, and the display device of a business operator C performs reception, rendering, and display control of the 3D content.

Furthermore, each functional block can be implemented on a cloud. For example, the rendering unit 17 may be implemented in the display device or may be implemented in a server. In this case, information is exchanged between the display device and the server.

In FIG. 1, the data acquisition unit 11, the 3D model generation unit 12, the formatting unit 13, the transmission unit 14, the reception unit 15, the decoding unit 16, the rendering unit 17, and the display unit 18 are collectively described as the information processing system 1. However, the information processing system 1 of the present specification may be referred to as an information processing system when two or more functional blocks are involved, and for example, the data acquisition unit 11, the 3D model generation unit 12, the formatting unit 13, the transmission unit 14, the reception unit 15, the decoding unit 16, and the rendering unit 17 can be collectively referred to as the information processing system 1 without including the display unit 18.

### <Flow of Processing of Information Processing System>

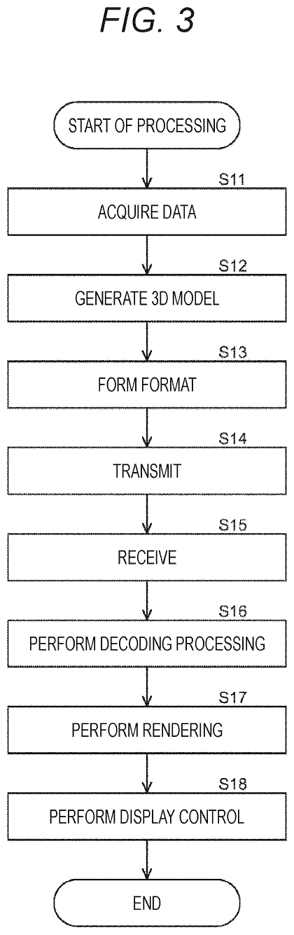

An example of a flow of processing of the information processing system 1 will be described with reference to a flowchart of FIG. 3. When the processing is started, in step S11, the data acquisition unit 11 acquires image data for generating a 3D model of the subject 31. In step S12, the 3D model generation unit 12 generates a model having three-dimensional information about the subject 31 on the basis of the image data for generating a 3D model of the subject 31. In step S13, the formatting unit 13 encodes the shape and texture data of the 3D model generated by the 3D model generation unit 12 into a format suitable for transmission and accumulation. In step S14, the transmission unit 14 transmits the encoded data, and in step S15, the reception unit 15 receives the transmitted data. In step S16, the decoding unit 16 performs decoding processing to convert the data into shape and texture data necessary for display. In step S17, the rendering unit 17 performs rendering using the shape and texture data. In step S18, the display unit 18 displays the rendering result. When the processing of step S18 ends, the processing by the information processing system ends.

### <Problem Due to Use of Rolling Shutter Type Imaging Camera 41>

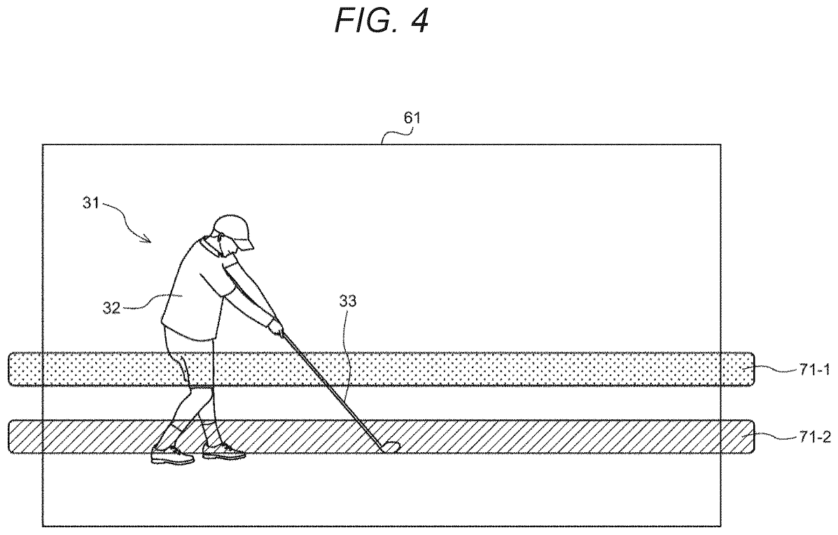

FIG. 4 is a diagram for explaining a problem caused by use of the rolling shutter type imaging camera 41. In FIG. 4, an image 61 exemplifies an image (captured image) for one frame captured by the rolling shutter type imaging camera 41 when a moving image is imaged by the plurality of imaging cameras 41 in FIG. 2. The subject 31, which is a target for generating a 3D model, includes a person 32 and a golf club 33 held by the person 32. The person 32 is swinging the golf club 33.

In the image 61 described above, in a case where the imaging method of the imaging camera 41 is the rolling shutter type, for example, exposure timings (imaging timings) of a scan line 71-1 and a scan line 71-2, which are scan lines at different positions, are different. That is, in imaging elements of the imaging camera 41, the exposure start time and the exposure stop time of light receiving elements on the scan line 71 are delayed by a certain time with respect to the exposure start time and the exposure stop time of light receiving elements on the scan line 72. Therefore, distortion occurs in an image of an object that moves fast such as the golf club 33 during the swing.

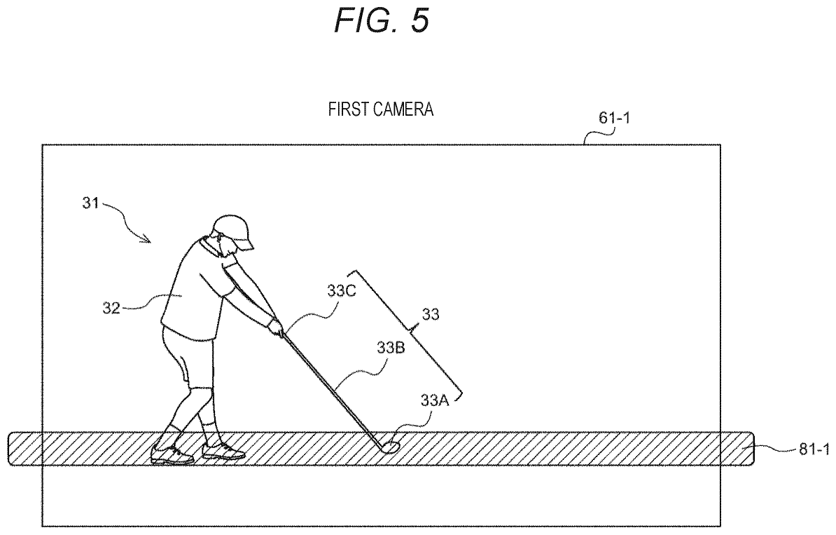

FIGS. 5 to 7 are diagrams exemplifying images of the subject 31 in FIG. 4 respectively captured by three imaging cameras 41 serving as the plurality of imaging cameras 41 in FIG. 2. Note that the three imaging cameras 41 are referred to as a first camera, a second camera, and a third camera, respectively. It is assumed that imaging methods of the first camera, the second camera, and the third camera are all rolling shutter types, and imaging is performed in synchronization with each other. FIGS. 5 to 7 are images of frames captured at the same time. In FIG. 5, an image 61-1 represents an image captured by the first camera. The first camera is the imaging camera 41 that has captured the image 61 in FIG. 4, and the image 61-1 is the same as the image 61 in FIG. 4.

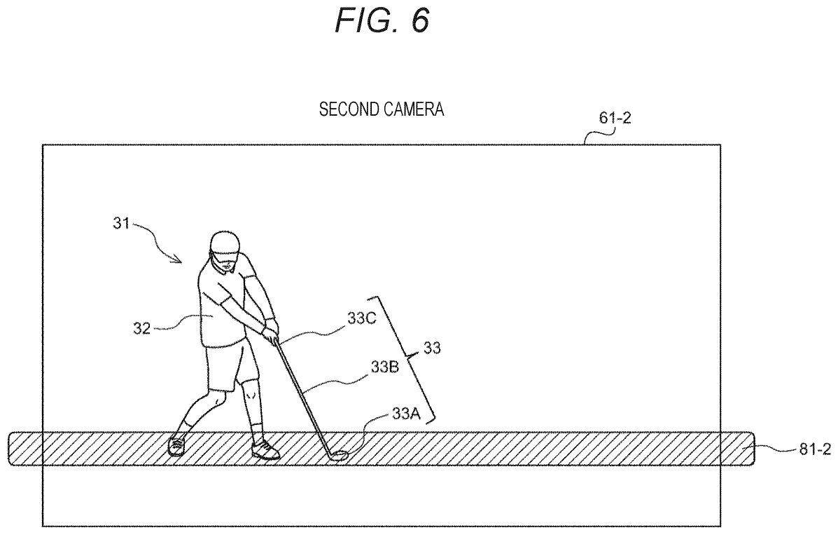

In FIG. 6, an image 61-2 represents an image captured by the second camera. Although the viewpoint of the second camera is different from that of the first camera, the image 61-2 shows the subject 31 including the person 32 and the golf club 33 similarly to the image 61-1.

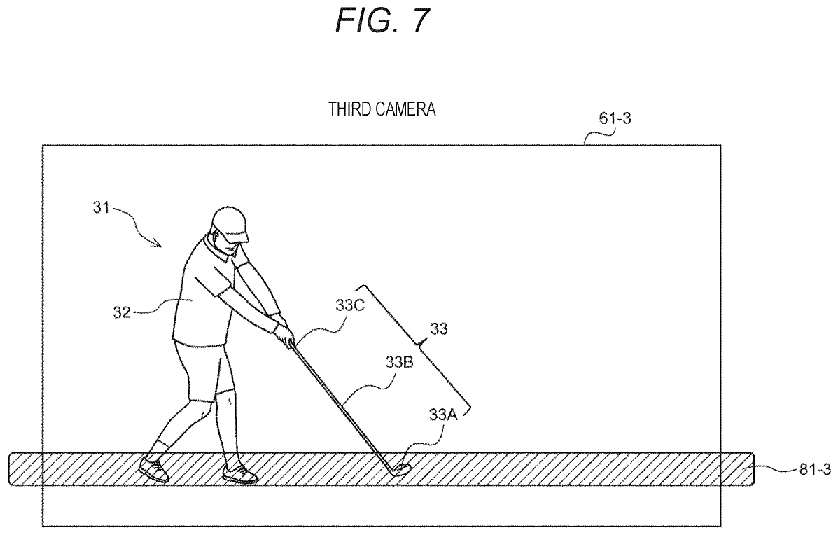

In FIG. 7, an image 61-3 represents an image captured by the third camera. Although the viewpoint of the third camera is different from those of the first camera and the second camera, the image 61-3 shows the subject 31 including the person 32 and the golf club 33 similarly to the images 61-1 and 61-2.

In FIGS. 5 to 7, the golf club 33 is divided into a head portion 33A at a distal end with which a golf ball is hit, a shaft portion 33B connecting the head portion 33A and a proximal end, and a grip portion 33C at the proximal end to be gripped by a player (person 32). During the swing, the movement of the head portion 33A is the fastest, and attention is paid to the head portion 33A. In FIGS. 5 to 7, scan lines 81-1 to 81-3 indicate positions of scan lines where the first camera to the third camera capture the head portion 33A, respectively. According to the scan lines 81-1 to 81-3, the positions in the vertical direction (up-down direction) of the scan lines 81-1 to 81-3 in the images 61-1 to 61-3 are different from each other. Therefore, the exposure timings (times) at which the first camera to the third camera expose the scan lines 81-1 to 81-3 are different from each other, and the timings (times) at which the first camera to the third camera image the head portion 33A are different from each other. That is, the three-dimensional positions of the head portion 33A in the real space when the first camera to the third camera image the head portion 33A are different from each other. In this case, it is assumed that the 3D model generation unit 12 in FIG. 1 generates the 3D shape data of the subject 31 by scraping the 3D shape of the subject 31 from the images 61-1 to 61-3 captured by the first camera to the third camera by visual hull (visual-volume intersection method). At this time, a section other than the head portion 33A of each of the images 61-1 to 61-3 scrapes the 3D shape of the head portion 33A. Therefore, a situation occurs in which the head portion 33A is lost (missing) in the 3D shape data generated by the 3D model generation unit 12. Although attention has been paid to the head portion 33A of the golf club 33, a section that moves fast such as the shaft portion 33B may also be lost from the 3D shape data.

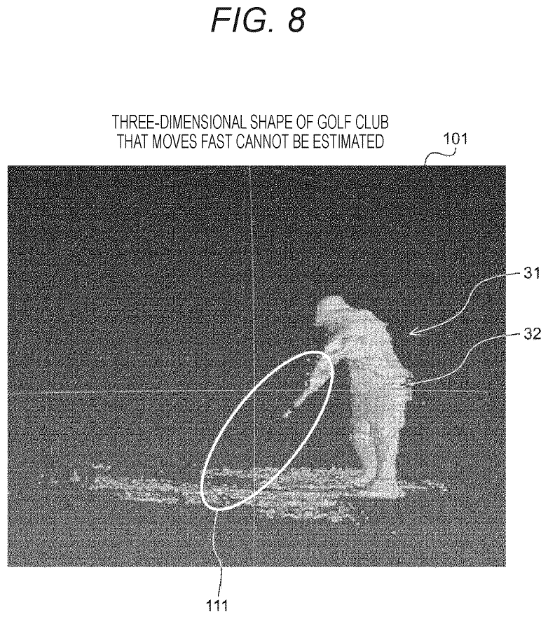

FIG. 8 is a diagram exemplifying a result in a case where the 3D model generation unit 12 generates 3D shape data on the basis of images of the subject 31 in FIGS. 4 to 7 captured by the plurality of rolling shutter type imaging cameras 41 (of a plurality of viewpoints). In FIG. 8, an image 101 is an image showing a virtual object of a 3D shape formed by 3D shape data generated by the 3D model generation unit 12 in a virtual three-dimensional space (virtual space). Note that a virtual object of a 3D shape (shape of a 3D model) formed by 3D shape data is simply referred to as 3D shape data. In the image 101, the 3D shape data of the section of the person 32 that does not move fast in the subject 31 is appropriately generated. In contrast, the 3D shape data of the section of the golf club 33 that moves fast in the subject 31 is not generated appropriately, and the 3D shape data of the golf club 33 is lost (missing) from a region 111 where the 3D shape data of the golf club 33 is to be generated.

As a result, in a case where the rendering unit 17 in FIG. 1 performs rendering using the 3D model generated by the 3D model generation unit 12, the golf club 33 is not drawn on the image displayed on the display unit 18.

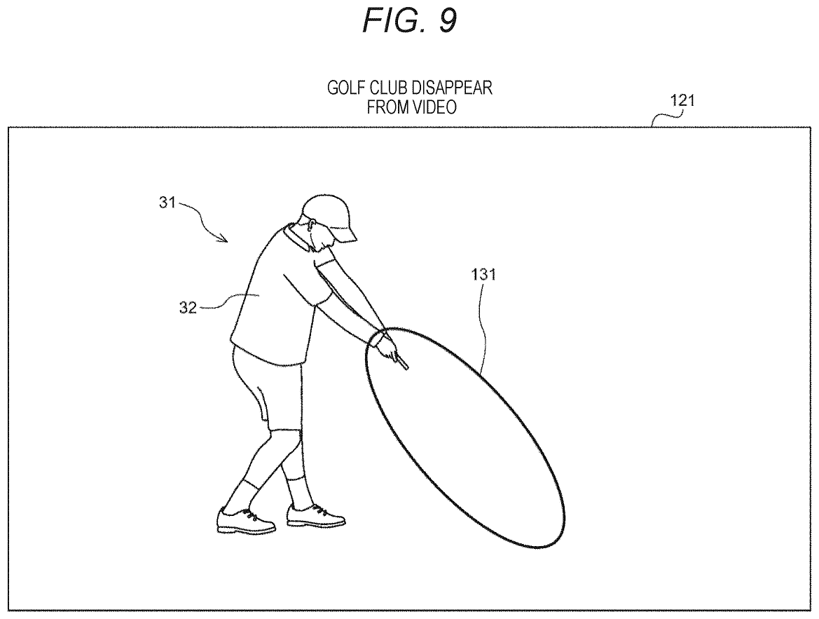

FIG. 9 is a diagram exemplifying an image rendered on the basis of the 3D shape data of FIG. 8. In FIG. 9, an image 121 is an image rendered on the basis of the 3D shape data of FIG. 8, and the person 32 whose 3D model has been appropriately generated in the subject 31 is appropriately drawn. In contrast, the golf club 33 for which 3D shape data is not appropriately generated is not drawn in a region 131 where it should originally exist. The present technology prevents a situation in which a part of a modeling target is missing when 3D shape data (3D model) of the modeling target is generated using an image captured by a rolling shutter type. Note that, in a case where one or more images among a plurality of images (of a plurality of viewpoints) for generating 3D shape data of the modeling target are images captured by the rolling shutter type, the above-described missing may occur. Even in a case where all of a plurality of images (of a plurality of viewpoints) for generating 3D shape data of a modeling target are images captured by the global shutter type, the above-described missing may occur when there is a difference in exposure timing (time). The present technology is also effective in these cases.

### Description of Present Technology

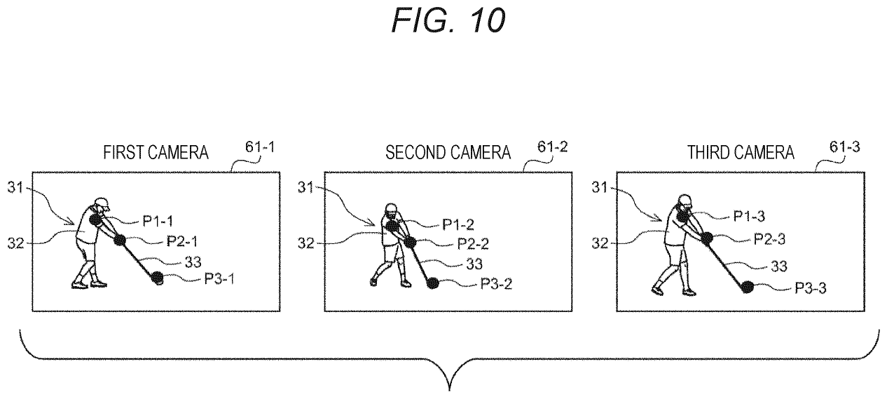

3D model generation processing to which the present technology is applied will be described with reference to FIGS. 10 to 14. The target (modeling target) for generating the 3D model is assumed to be the person and the golf club illustrated in FIG. 4 and the like, and the images used for generating the 3D model are assumed to be three images captured by the rolling shutter type first camera to third camera.

FIG. 10 is a diagram showing the images shown in FIGS. 5 to 7 side by side. Note that, in the drawing, sections common to those in the images in FIGS. 5 to 7 are denoted by the same reference numerals, and the description thereof will be omitted.

### (Object Recognition Processing)

When images 61-1 to 61-3 of frames captured at the same time by the rolling shutter type first camera to third camera are supplied from the data acquisition unit 11, the 3D model generation unit 12 in FIG. 1 recognizes the types of object and part included in the images 61-1 to 61-3 by object recognition processing on each of the images 61-1 to 61-3, and detects the image regions or positions of the recognized objects and parts. Types of object and part to be recognized include at least one or more types of object or part to be modeling targets. The types of object and part to be recognized may be appropriately changed according to the modeling target. Examples of the type of object to be recognized include a type of integral object such as a person or an animal. Examples of the type of part to be recognized include a type of portion that is a part of an integral object such as an arm or a hand of a person. A tool (such as a tool used by a person) such as a golf club may be recognized as a type of object or may be recognized as a type of part. A portion of a tool such as a head portion or a grip portion of a golf club may also be recognized as a type of part. Such object recognition processing is performed using, for example, an inference model having a structure of a neural network generated by a machine learning technology. In a case where a person and a golf club are recognized by the object recognition processing, the 3D model generation unit 12 detects image regions of them and the positions of a shoulder and a hand of the person and the head portion of the golf club. In a case where the object recognition processing is performed on each of the images 61-1 to 61-3, for example, the image regions of the person 32 and the golf club 33 in each of the images 61-1 to 61-3 are detected, and positions P1-1 to P1-3 of the shoulder and positions P2-1 to P2-3 of the hand of the person 32, and positions P3-1 to P3-3 of the head portion of the golf club are detected.

### (3D Shape Data Generation Processing)

When the 3D model generation unit 12 detects the image regions of the person 32 and the golf club 33 included in each of the images 61-1 to 61-3 by the object recognition processing, the 3D model generation unit 12 generates 3D shape data of the person 32 and the golf club 33, which are modeling targets, using a visual hull (visual-volume intersection method) on the basis of the detected image regions by 3D shape data generation processing.

### (Part Position Estimation Processing)

Furthermore, when the 3D model generation unit 12 detects the positions P1-1 to P1-3 of the shoulder and the positions P2-1 to P2-3 of the hand of the person 32, and the positions P3-1 to P3-3 of the head portion of the golf club included in each of the images 61-1 to 61-3 by the object recognition processing, the 3D model generation unit 12 estimates the three-dimensional position of the shoulder and the three-dimensional position of the hand of the person 32, and the three-dimensional position of the head portion of the golf club on the basis of the detected positions by part position estimation processing. For example, in a case where the three-dimensional position of a predetermined target point is calculated from the position of the target point on the image, a result of camera calibration performed in advance is used. A specific method of deriving the three-dimensional position of the target point from the position of the target point on the image is not limited to a specific method, but for example, when the three-dimensional position of the target point is calculated from the position of the target point on one image, a plurality of three-dimensional positions is calculated as the three-dimensional position of the target point appearing in a plurality of images. Assuming that the three-dimensional position of the target point is calculated from the positions of the target point in the two images by the principle of triangulation, a plurality of three-dimensional positions is calculated as the three-dimensional position of the target point by replacing the combination of the two images. In a case where a portion that does not move fast is the target point, since the plurality of calculated three-dimensional positions of the target point substantially coincide with each other, the 3D model generation unit 12 estimates one of the calculation results as the three-dimensional position of the target point. In a case where a portion that moves fast is the target point, the plurality of calculated three-dimensional positions of the target point vary, so that the 3D model generation unit 12 estimates the three-dimensional position of the target point on the basis of the plurality of calculated three-dimensional positions of the target point. For example, the 3D model generation unit 12 calculates a barycentric position of the plurality of calculated three-dimensional positions of the target point, and estimates the calculated barycentric position as the three-dimensional position of the target point. Note that, regardless of the degree of variation, the barycentric position of the plurality of calculated three-dimensional positions of the target point may be estimated as the three-dimensional position of the target point.

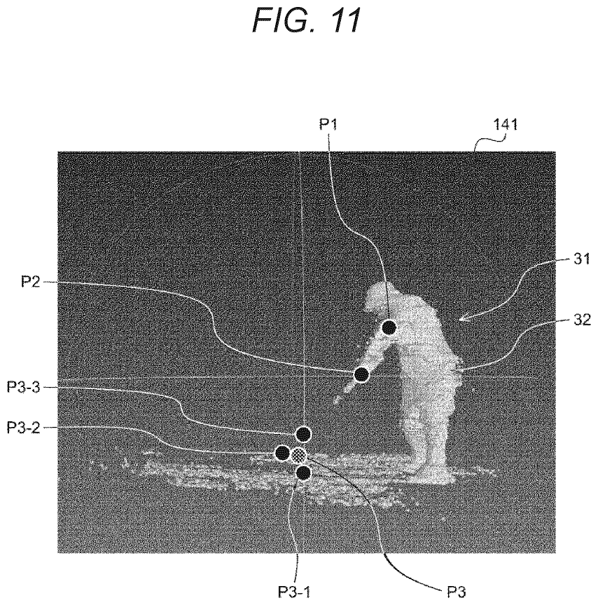

FIG. 11 is a diagram for explaining the part position estimation processing. In FIG. 11, an image 141 is an image showing 3D shape data generated by the 3D shape data generation processing in a virtual space, similarly to the image 101 of FIG. 8. In FIG. 11, a three-dimensional position P1 of the shoulder and a three-dimensional position P2 of the hand of the person 32 shown in the image 141 represent the three-dimensional positions estimated from the positions P1-1 to P1-3 of the shoulder and the positions P2-1 to P2-3 of the hand of the person 32 in the images 61-1 to 61-3 detected by the object recognition processing, respectively. Since the shoulder and the hand do not move fast, a plurality of three-dimensional positions calculated from the positions of the shoulder and the hand in each of the images 61-1 to 61-3 substantially coincide with each other. The three-dimensional positions P3-1 to P3-3 of the head portion of the golf club shown in the image 141 represent a plurality of three-dimensional positions calculated from the positions P3-1 to P3-3 of the head portion of the golf club in the respective images 61-1 to 61-3 detected by the object recognition processing, respectively. Since the head portion moves fast, variations occur in the plurality of three-dimensional positions P3-1 to P3-3 calculated from the positions P3-1 to P3-3 of the head portion of the golf club in the respective images 61-1 to 61-3. The three-dimensional position P3 shown in the image 141 represents the barycentric position of the plurality of three-dimensional positions P3-1 to P3-3 of the head portion of the golf club, and the three-dimensional position P3 is estimated as the three-dimensional position of the head portion of the golf club.

### (Interpolation Processing)

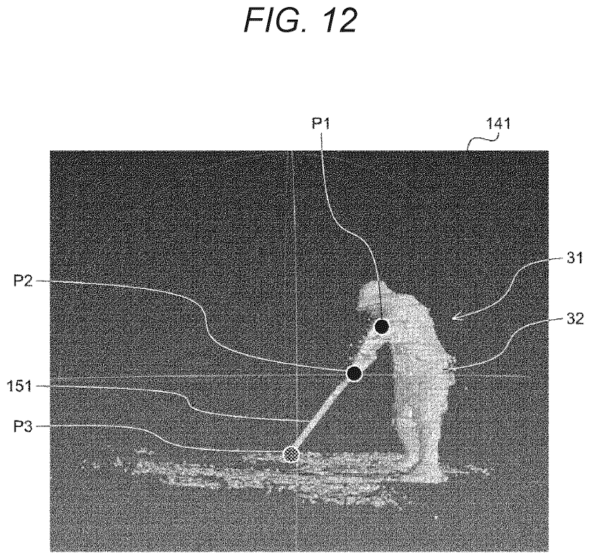

In a case where an object or part, which is a modeling target, is partially or entirely missing in 3D shape data generated by the 3D shape data generation processing, the 3D model generation unit 12 interpolates (adds) the 3D shape data of the missing section (missing section) by interpolation processing. In the interpolation processing, the three-dimensional position estimated by the part position estimation processing is referred to. In the image 141 of FIG. 11, substantially the entire 3D shape data of the golf club 33 is missing, so in that case the 3D model generation unit 12 interpolates the 3D shape data of the golf club 33 as in FIG. 12 in the region where the golf club 33 should originally exist. Note that, whether or not the object or part, which is the modeling target, is partially or entirely missing may be determined in the basis of whether or not the modeling target that should originally exist exists appropriately on the basis of the 3D shape data generated by the 3D shape data generation processing, or may be determined on the basis of the degree of variation in the three-dimensional position of the predetermined portion calculated from each image when the three-dimensional position of the predetermined section of the modeling target is estimated by the part position estimation processing, and is not limited to a specific method.

FIG. 12 is a diagram for explaining the interpolation processing. Note that, in the drawing, sections common to those in the image 141 in FIG. 11 are denoted by the same reference numerals, and the description thereof will be omitted. In FIG. 12, the region where the golf club 33 should originally exist is detected as a region linearly connecting the three-dimensional position P2 of the hand of the person 32 estimated by the part position estimation processing and the three-dimensional position P3 (position included in the missing section) of the head portion of the golf club. The 3D model generation unit 12 interpolates the 3D shape data of the golf club by adding 3D shape data 151 of the golf club prepared in advance to the region where the golf club 33 should originally exist, for the 3D shape data generated by the 3D shape data generation processing.

### (Texture Generation Processing)

The 3D model generation unit 12 generates a texture to be pasted to the 3D shape data at the time of rendering, for the 3D shape data after the interpolation processing, by texture generation processing. The texture includes a view independent texture and a view dependent texture as described above. In a case of generating either texture, the 3D model generation unit 12 extracts an image of an object or part, which is a modeling target, from each of the images 61-1 to 61-3, and generates a texture using the extracted images. In each of the images 61-1 to 61-3, since the image region of the object or part which is the modeling object, is detected by the object recognition processing, the 3D model generation unit 12 may extract the image of the image region of the modeling object detected by the object recognition processing from each of the images 61-1 to 61-3. Furthermore, the 3D model generation unit 12 generates a texture by using the image of the modeling target extracted from each of the images 61-1 to 61-3 regardless of whether or not the section is a section of the modeling target obtained by interpolating the 3D shape data by the interpolation processing.

For example, in the view dependent method, a texture (view dependent texture) used at the time of rendering is generated using an image of the modeling target extracted from an image captured by an imaging camera closest to a virtual viewpoint. In consideration of the fact that the virtual viewpoint is freely changed, textures corresponding to the respective virtual viewpoints are generated by using the images of the modeling target extracted from the respective images 61-1 to 61-3.

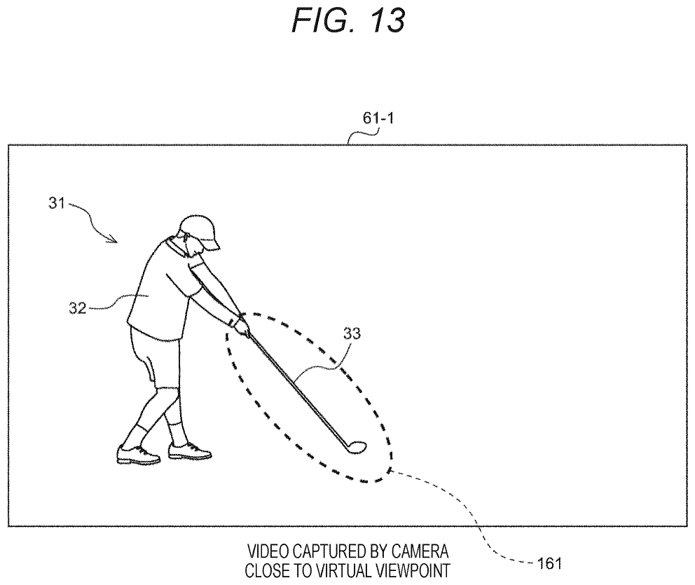

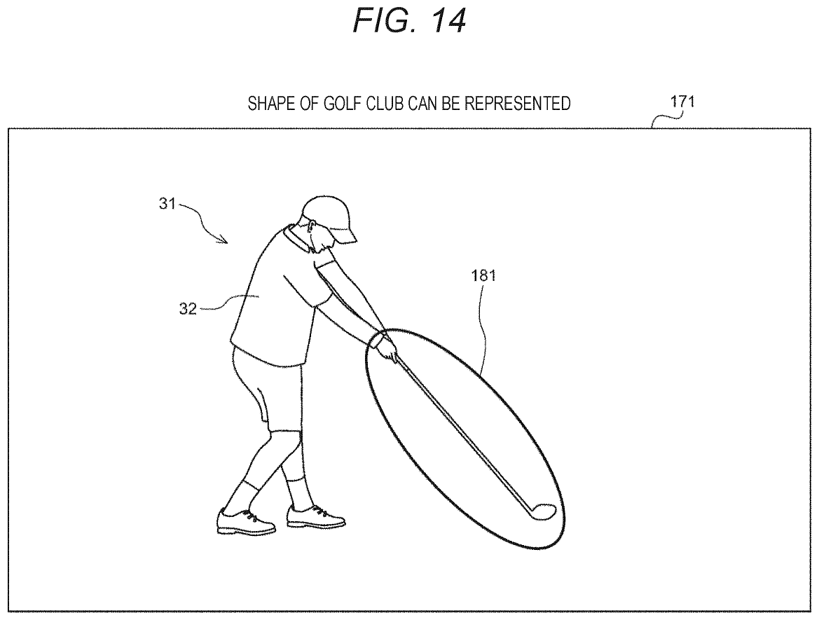

FIG. 13 is a diagram for explaining a case where a texture is generated from the image 61-1 of FIG. 5. In FIG. 13, the person 32 and the golf club 33 in the image 61-1 are modeling targets. In the 3D shape data generated by the 3D shape data generation processing as described with reference to FIG. 9, the 3D shape data of the golf club 33 is lost, and the 3D shape data of the golf club is interpolated by the interpolation processing as described with reference to FIG. 12. The 3D model generation unit 12 extracts an image of an image region of the person 32 and an image of an image region of the golf club 33 (an image of the image region 161 including the golf club 33), which are the modeling targets, included in the image 61-1, as a texture to be used in a case where the first camera that has captured the image 61-1 is close to the virtual viewpoint at the time of rendering, and generates a texture. At that time, the image region of the golf club 33 in the image 61-1 in which the 3D shape data has been lost and the image region in the image generated by rendering the golf club interpolated by the interpolation processing may be different in position and shape. Therefore, the position and shape of the image of the golf club 33 are appropriately corrected to match the image regions each other and the texture is generated. As a result, in a case where rendering is performed with a position close to the viewpoint of the first camera that has captured the image 61-1 as a virtual viewpoint, the image of the golf club is appropriately represented as illustrated in a region 181 of an image 171 in FIG. 14.

As described above, in a case where 3D shape data (3D model) of a modeling target is generated on the basis of a plurality of images (of a plurality of viewpoints), if a section with the timing of exposure being different for each image and that moves fast exists in the modeling target, the section is missing from the 3D shape data. According to the present technology, since the 3D shape data of such a missing section is interpolated, the 3D shape data (3D model) of the modeling target is appropriately generated. In the technology of Patent Document 1 (Japanese Patent Application Laid-Open No. 2013-120435), it is necessary to obtain the corresponding points between the images with accuracy close to the Pixel unit, and thus it is practically difficult to adopt the technology. Furthermore, even if the correspondence relationship is accurately obtained, it is difficult to correctly estimate the distortion of the rolling shutter. On the other hand, in the present technology, the rolling shutter distortion itself is not estimated, but the position of a portion where the missing may occur or a portion (hand, distal end of golf club) interlocked with the portion is detected, and three-dimensional interpolation of the missing section is performed from the positional relationship of the portions, so that the processing is overwhelmingly simplified. Furthermore, in the present technology, strictly speaking, the missing section is not accurately reproduced, but an appropriate 3D model without discomfort is generated, and a situation in which the missing section occurs in the 3D model is reliably prevented.

<Configuration Example of 3D Model Generation Unit 12 to which Present Technology is Applied>

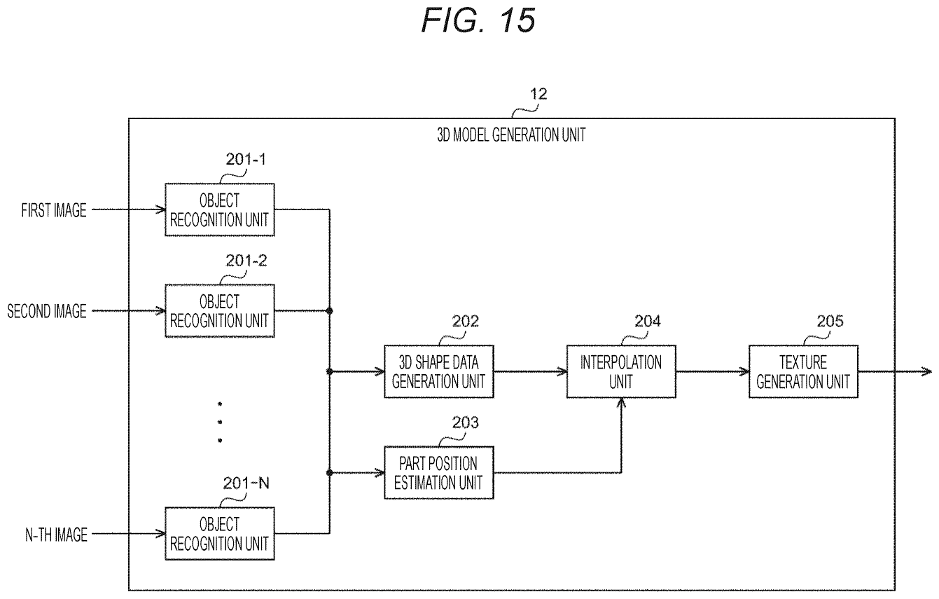

FIG. 15 is a block diagram illustrating a configuration example of the 3D model generation unit 12 to which the present technology is applied. In FIG. 15, the 3D model generation unit 12 includes object recognition units 201-1 to 201-N (N is the number of input images), a 3D shape data generation unit 202, a part position estimation unit 203, an interpolation unit 204, and a texture generation unit 205.

### (Object Recognition Units 201-1 to 201-N)

First to N-th images supplied from the data acquisition unit 11 in FIG. 1 are input to the object recognition units 201-1 to 201-N, respectively. The first to N-th images are images obtained by capturing the modeling target from different viewpoint positions, and are images of frames captured at the same time. The first to N-th images are images captured by either the rolling shutter type or the global shutter type, and all the images may be images captured by the rolling shutter type or the global shutter type, or the images captured by the rolling shutter type and the images captured by the global shutter type may be mixed.

When the first to N-th images are supplied from the data acquisition unit 11, the object recognition units 201-1 to 201-N recognize the types of objects and parts included in the first to N-th images by the object recognition processing, and detect the image regions or positions of the recognized objects and parts. Types of object and part to be recognized include at least a modeling target. The object recognition processing is performed using, for example, an inference model having a structure of a neural network generated by a machine learning technology. The object recognition units 201-1 to 201-N detect image regions or positions of objects or parts recognized in the first to N-th images, respectively. The object recognition units 201-1 to 201-N supply the types and the image regions of the detected objects or parts to the 3D shape data generation unit 202 as recognition results. The object recognition units 201-1 to 201-N supply the types and the positions of the detected objects or parts to the part position estimation unit 203 as recognition results.

### (3D Shape Data Generation Unit 202)

The 3D shape data generation unit 202 generates 3D shape data of the modeling target by the 3D shape data generation processing on the basis of the recognition results from the object recognition units 201-1 to 201-N. In the 3D shape data generation processing, for example, visual hull (visual-volume intersection method) is used. The 3D shape data generation unit 202 supplies the generated 3D shape data to the interpolation unit 204.

### (Part Position Estimation Unit 203)

On the basis of the recognition results from the object recognition units 201-1 to 201-N, the part position estimation unit 203 estimates the three-dimensional position of a predetermined type of part (including a case of an object) by part position estimation processing. For example, a three-dimensional position of a part that may move fast and a part that interlocks with the part is estimated. In the part position estimation processing, the three-dimensional position of the part is calculated on the basis of the position of the part in each of the first to N-th images. As a result, a plurality of three-dimensional positions of the part is calculated, and in a case where the part moves fast or the like, the plurality of calculated three-dimensional positions may vary. In a case where the calculate three-dimensional positions of the plurality of parts vary, for example, the part position estimation unit 203 estimates the barycentric position of the three-dimensional positions as the three-dimensional position of the part. The part position estimation unit 203 supplies the estimated three-dimensional position of the part to the interpolation unit 204.

### (Interpolation Unit 204)

In a case where an object or part, which is a modeling target, is partially or entirely missing in 3D shape data supplied from the 3D shape data generation unit 202, the interpolation unit 204 interpolates (adds) the 3D shape data of the missing section (missing section) by the interpolation processing. In this interpolation processing, the interpolation unit 204 specifies (limits) a region (three-dimensional region) in which the missing section should originally exist on the basis of the three-dimensional position of the part estimated by the part position estimation unit 203, and adds 3D shape data of the missing section prepared (stored) in advance to the specified region. As a result, 3D shape data of the modeling target without a missing section is generated and supplied to the texture generation unit 205.

### (Texture Generation Unit 205)

The texture generation unit 205 generates a texture to be pasted to the 3D shape data at the time of rendering, for the 3D shape data of the modeling target from the interpolation unit 204, by texture generation processing. In the texture generation processing, the texture generation unit 205 extracts an image of an image region of the modeling target from each of the first to N-th images, and generates a texture on the basis of the extracted image. For the image of the texture to be pasted to the missing section (interpolated section) interpolated by the interpolation unit 204, the texture generation unit 205 extracts an image corresponding to the interpolated section from each of the first to N-th images similarly to the image of the non-missing section. However, since the 3D shape of the interpolated section may be different from the actual shape, the texture generation unit 205 appropriately corrects the pasting position and shape of the extracted image so that the image from which the texture is extracted is appropriately pasted to the interpolation portion. The texture generation unit 205 supplies, to the formatting unit 13 in FIG. 1, the data of the 3D model in which the texture data is associated with the 3D shape data of the modeling target from the interpolation unit 204.

<Processing Procedure of 3D Model Generation Unit 12 to which Present Technology is Applied>

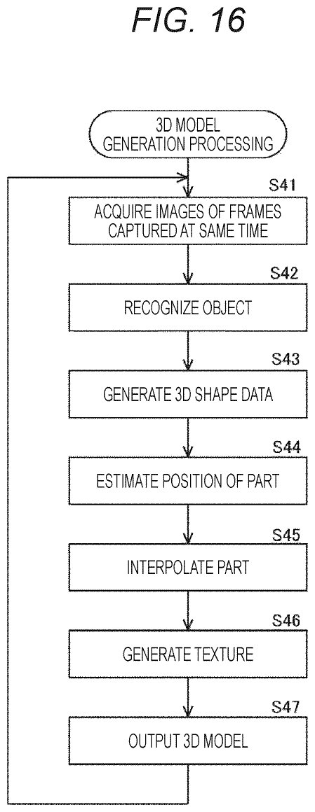

FIG. 16 is a flowchart exemplifying a procedure of the 3D model generation processing performed by the 3D model generation unit 12. In step S41, the object recognition units 201-1 to 201-N acquire images (first image to N-th image) of frames captured at the same time, respectively. The processing proceeds from step S41 to step S42.

In step S42, the object recognition units 201-1 to 201-N perform the object recognition processing on the first to N-th images acquired in step S41, respectively, and detect the image regions or positions of the object or part to be recognized. The processing proceeds from step S42 to step S43.

In step S43, the 3D shape data generation unit 202 performs the 3D shape data generation processing on the basis of the recognition results from the object recognition units 201-1 to 201-N obtained in step S42, and generates 3D shape data of the modeling target. The processing proceeds from Step S43 to Step S44.

In step S44, the part position estimation unit 203 performs the part position estimation processing on the basis of the recognition results from the object recognition units 201-1 to 201-N obtained in step S42, and estimates the three-dimensional position of a predetermined part. The processing proceeds from step S44 to step S45.

In step S45, the interpolation unit 204 interpolates, by the interpolation processing, the 3D shape data of a missing section in the 3D shape data of the modeling target generated in step S43 using the three-dimensional position of the part estimated in step S44. As a result, the interpolation unit 204 generates the 3D shape data of the modeling target without the missing section. The processing proceeds from step S45 to step S46.

In step S46, the texture generation unit 205 generates, by the texture generation processing, a texture to be pasted to the 3D shape data of the modeling target generated in step S45. In the generation of the texture, the image of the image region of the modeling target in each of the first to N-th images acquired in step S41 is used. The processing proceeds from step S46 to step S47.

In step S47, the texture generation unit 205 associates the 3D shape data of the modeling target generated in step S45 with the texture generated in step S46, and output them as 3D model data to the formatting unit 13 in FIG. 1. After step S47, the processing returns to step S41.

<Other Specific Examples of 3D Model Generation Processing to which Present Technology is Applied>

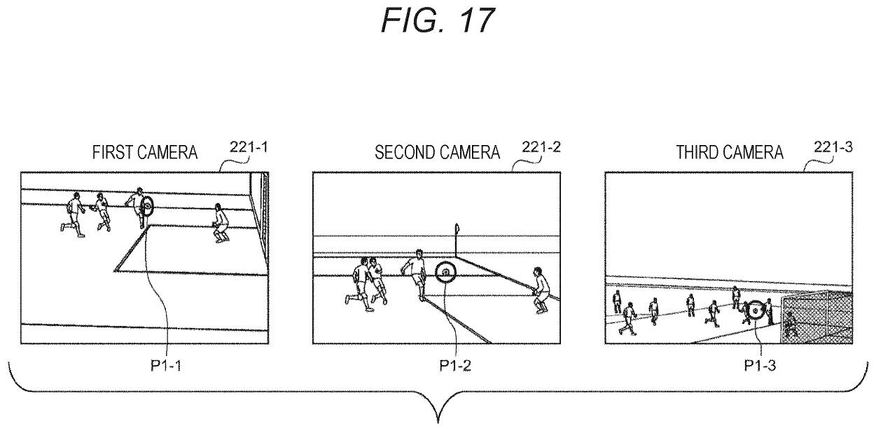

FIGS. 17 to 19 are diagrams for explaining 3D model generation processing in a case where the modeling target is a person playing soccer and a soccer ball. Images 221-1 to 221-3 in FIG. 17 represent images of frames captured by the rolling shutter type first camera to third camera at the same time similarly to FIG. 10, respectively. In each of the images 221-1 to 221-3, a plurality of persons who are players and a soccer ball are shown. Positions P1-1 to P1-3 in the respective images 221-1 to 221-3 represent the positions of the soccer ball.

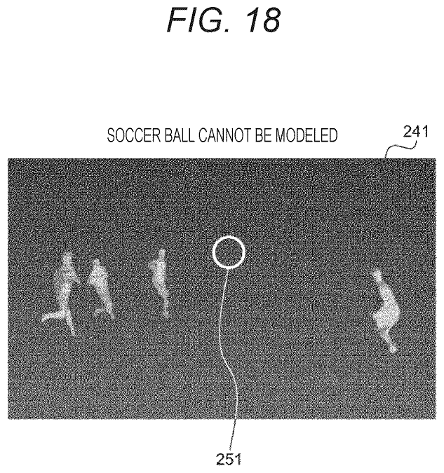

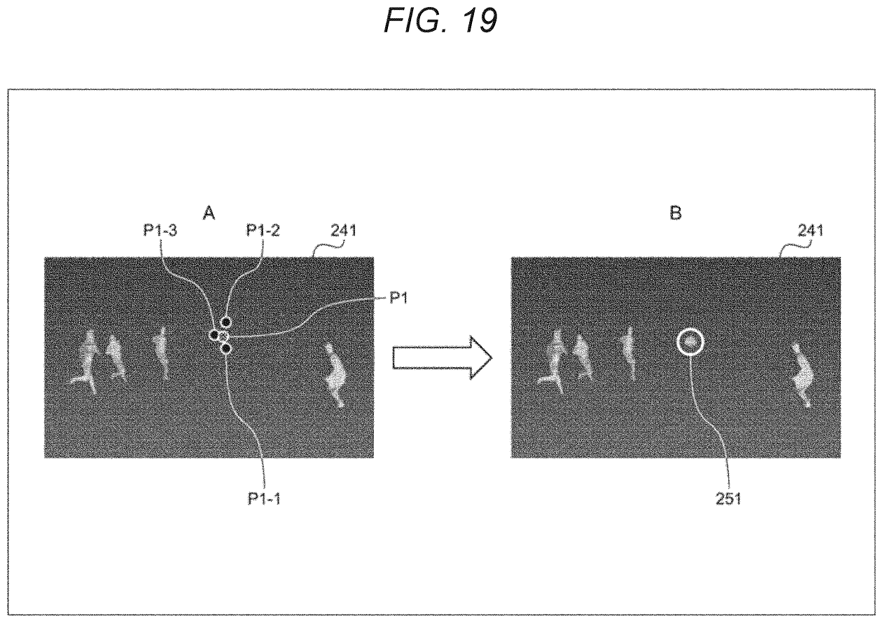

The object recognition units 201-1 to 201-N (N=3) of the 3D model generation unit 12 perform the object recognition processing on the images 221-1 to 221-3, and the 3D shape data generation unit 202 generates the 3D shape data of the persons and the soccer ball, which are modeling targets, by the 3D shape data generation processing on the basis of the recognition results. An image 241 in FIG. 18 is a figure showing 3D shape data generated by the 3D shape data generation processing in a virtual space. According to this image, when the soccer ball moves fast, the soccer ball does not exist in a region 251 where the soccer ball should originally exist, and the 3D shape data of the soccer ball, which is the modeling target, is missing. In contrast, the part position estimation unit 203 estimates the three-dimensional position of the soccer ball by the part position estimation processing on the basis of the positions P1-1 to P1-3 of the soccer ball in the images 221-1 to 221-3. In the image 241 in A of FIG. 19, a three-dimensional position P1 represents the three-dimensional position of the soccer ball estimated by the part position estimation processing. The three-dimensional positions P1-1 to P1-3 represent three-dimensional positions calculated on the basis of the positions P1-1 to P1-3 of the soccer ball in the images 221-1 to 221-3, respectively. The three-dimensional position P1 of the soccer ball is estimated as the barycentric position of the three-dimensional positions P1-1 to P1-3. The interpolation unit 204 adds (interpolates), by the interpolation processing, the 3D shape data of the soccer ball to the three-dimensional position P1 of the soccer ball estimated by the part position estimation unit 203, for the 3D shape data generated by the 3D shape data generation unit 202. As a result, as illustrated in the image 241 in B of FIG. 19, the 3D shape data of the soccer ball is added to the region 251 where the soccer ball should originally exist, for the 3D shape data of the modeling target. The texture generation unit 205 generates a texture to be pasted to the 3D shape data of the modeling target interpolated with the 3D shape data of the soccer ball by the interpolation unit 204, from the images of the modeling target extracted from the respective images 221-1 to 221-3.

### <Program>

A series of processing in the information processing system 1 or the 3D model generation unit 12 described above can be executed by hardware or software. In a case where the series of processing is performed by the software, a program forming the software is installed into a computer. Here, examples of the computer include a computer incorporated in dedicated hardware, and a general-purpose personal computer capable of executing various functions by installing various programs, for example.

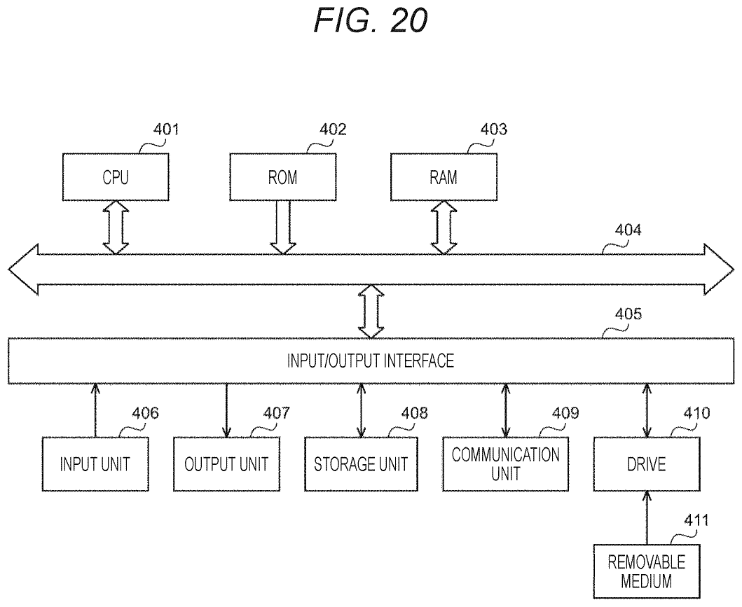

FIG. 20 is a block diagram illustrating a configuration example of the hardware of the computer in a case where the computer executes each processing executed by the information processing system 1 or the 3D model generation unit 12 with a program.

In the computer, a central processing unit (CPU) 401, a read only memory (ROM) 402, and a random access memory (RAM) 403 are mutually connected by a bus 404.

An input/output interface 405 is further connected to the bus 404. An input unit 406, an output unit 407, a storage unit 408, a communication unit 409, and a drive 410 are connected to the input/output interface 405.

The input unit 406 includes a keyboard, a mouse, a microphone, and the like. The output unit 407 includes a display, a speaker, and the like. The storage unit 408 includes a hard disk, a nonvolatile memory, and the like. The communication unit 409 includes a network interface and the like. The drive 410 drives a removable medium 411 such as a magnetic disk, an optical disk, a magneto-optical disk, a semiconductor memory, or the like.

In the computer configured as described above, for example, the CPU 401 loads a program stored in the storage unit 408 into the RAM 403 via the input/output interface 405 and the bus 404 and executes the program, so that the above-described series of processing is performed.

The program executed by the computer (CPU 401) can be provided by being recorded in the removable medium 411 as a package medium or the like, for example. Also, the program can be provided via a wired or wireless transmission medium such as a local area network, the Internet, or digital satellite broadcasting.

In the computer, the program can be installed in the storage unit 408 via the input/output interface 405 by attaching the removable medium 411 to the drive 410. Furthermore, the program can be received by the communication unit 409 via a wired or wireless transmission medium and installed in the storage unit 408. In addition, the program can be installed in the ROM 402 or the storage unit 408 in advance.

Note that, a program to be executed by the computer may be a program by which pieces of processing are performed in time series in the order described in the present specification, or may be a program by which pieces of processing are performed in parallel or a piece of processing may be performed at a required time such as when a call is made.

### Application Examples

The technology according to the present disclosure can be applied to various products and services.

### (1. Production of Content)

For example, new video content may be produced by combining the 3D model of a subject generated in the present embodiment with 3D data managed by another server. Furthermore, for example, in a case where there is background data acquired by an imaging device such as Lidar, content as if the subject is at a place indicated by the background data can be produced by combining the 3D model of the subject generated in the present embodiment and the background data. Note that the video content may be three-dimensional video content or two-dimensional video content converted into two dimensions. Note that examples of the 3D model of the subject generated in the present embodiment include a 3D model generated by the 3D model generation unit and a 3D model reconstructed by the rendering unit, and the like.

### (2. Experience in Virtual Space)

For example, the subject (for example, a performer) generated in the present embodiment can be arranged in a virtual space that is a place where the user communicates as an avatar. In this case, the user has an avatar and can view a subject of a live image in the virtual space.

(3. Application to Communication with Remote Location)

For example, by transmitting the 3D model of the subject generated by the 3D model generation unit from the transmission unit to a remote location, a user at the remote location can view the 3D model of the subject through a reproduction device at the remote location. For example, by transmitting the 3D model of the subject in real time, the subject and the user at the remote location can communicate with each other in real time. For example, a case where the subject is a teacher and the user is a student, or a case where the subject is a physician and the user is a patient can be assumed.

### (4. Others)

For example, a free viewpoint video of a sport or the like can be generated on the basis of the 3D models of the plurality of subjects generated in the present embodiment, or an individual can distribute himself/herself, which is a 3D model generated in the present embodiment, to a distribution platform. As described above, the contents in the embodiments described in the present description can be applied to various technologies and services.

Furthermore, for example, the above-described programs may be executed in any device. In this case, the device is only required to have a necessary functional block and obtain necessary information.

Furthermore, for example, each step of one flowchart may be executed by one device, or may be shared and executed by a plurality of devices. Moreover, in a case where a plurality of pieces of processing is included in one step, the plurality of pieces of processing may be executed by one device, or may be shared and executed by a plurality of devices. In other words, a plurality of pieces of processing included in one step can be executed as a plurality of steps. Conversely, the processing described as the plurality of the steps can also be collectively executed as one step.

Furthermore, for example, in a program executed by the computer, processing of steps describing the program may be executed in a time-series order in the order described in the present specification, or may be executed in parallel or individually at a required timing such as when a call is made. That is, as long as there is no contradiction, the processing of each step may be executed in an order different from the above-described order. Moreover, the processing in the steps describing the program may be executed in parallel with processing of another program, or may be executed in combination with processing of the other program.

Furthermore, for example, a plurality of technologies related to the present technology can be implemented independently as a single entity as long as there is no contradiction. It goes without saying that any plurality of present technologies can be implemented in combination. For example, a part or all of the present technologies described in any of the embodiments can be implemented in combination with a part or all of the present technologies described in other embodiments. Furthermore, a part or all of any of the above-described present technologies can be implemented together with another technology that is not described above.

The present technology may also have the following configurations.

(1)

An information processing device including:
a 3D shape data generation unit configured to generate 3D shape data representing a 3D shape of a modeling target, which is a target for generating a 3D model, on the basis of a plurality of captured images obtained by capturing the modeling target from different viewpoint positions; and
an interpolation unit configured to interpolate 3D shape data of a missing section of the modeling target, the missing section being missing in 3D shape data generated by the 3D shape data generation unit.
   (2)

The information processing device according to (1), in which the 3D shape data generation unit generates the 3D shape data on the basis of an image region of the modeling target in each of the plurality of captured images.

(3)

The information processing device according to (2), in which the 3D shape data generation unit generates the 3D shape data using a visual-volume intersection method.

(4)

The information processing device according to (2) or (3), further including
an image recognition unit configured to recognize the modeling target in each of the plurality of captured images and detect the image region of the modeling target that has been recognized.
   (5)

The information processing device according to (4), in which the image recognition unit recognizes the modeling target by an inference model having a structure of a neural network generated by machine learning.

(6)

The information processing device according to (1) to (5), in which the interpolation unit specifies a three-dimensional region in which the missing section should originally exist on the basis of a three-dimensional position of a predetermined portion of the modeling target estimated by a position of a predetermined portion of the modeling target in each of the plurality of captured images, and adds 3D shape data of the missing section to the three-dimensional region that has been specified.

(7)

The information processing device according to (6), further including
a position estimation unit configured to estimate the three-dimensional position of the predetermined portion on the basis of a position of the predetermined portion of the modeling target in each of the plurality of captured images.
   (8)

The information processing device according to (7), in which the position estimation unit calculates a plurality of three-dimensional positions as the three-dimensional position of the predetermined portion on the basis of a position of the predetermined portion of the modeling target in each of the plurality of captured images, and estimates the three-dimensional position of the predetermined portion on the basis of the plurality of three-dimensional positions that have been calculated.

(9)

The information processing device according to (8), in which the position estimation unit estimates a barycentric position of the plurality of the three-dimensional positions that have been calculated, as the three-dimensional position of the predetermined portion.

(10)

The information processing device according to 6) to (9), in which the predetermined portion of the modeling target is a portion included in the missing section.

(11)

The information processing device according to (1) to (10), further including
a texture generation unit configured to generate a texture to be pasted to the 3D shape data on the basis of an image of the modeling target in each of the plurality of captured images.
   (12)

The information processing device according to (1) to (11), in which any one or more of the plurality of captured images are captured images captured by a rolling shutter type.

(13)

The information processing device according to (1) to (12), in which the modeling target includes a plurality of types of objects.

(14)

The information processing device according to (1) to (13), in which the modeling target includes a person.

(15)

The information processing device according to (1) to (14), in which the modeling target includes a tool used by a person.

(16)

An information processing method performed by
an information processing device including
a 3D shape data generation unit and an interpolation unit, the method including:
generating, by the 3D shape data generation unit, 3D shape data representing a 3D shape of a modeling target, which is a target for generating a 3D model, on the basis of a plurality of captured images obtained by capturing the modeling target from different viewpoint positions; and
interpolating, by the interpolation unit, 3D shape data of a missing section of the modeling target, the missing section being missing in the 3D shape data.
   (17)

A program causing a computer to function as:
a 3D shape data generation unit configured to generate 3D shape data representing a 3D shape of a modeling target, which is a target for generating a 3D model, on the basis of a plurality of captured images obtained by capturing the modeling target from different viewpoint positions; and
an interpolation unit configured to interpolate 3D shape data of a missing section of the modeling target, the missing section being missing in 3D shape data generated by the 3D shape data generation unit.

### REFERENCE SIGNS LIST

1 Information processing system
11 Data acquisition unit
12 Data acquisition unit
12 3D model generation unit
13 Formatting unit
14 Transmission unit
15 Reception unit
16 Decoding unit
17 Rendering unit
18 Display unit
31 Subject
32 Person
33 Golf club
41 Imaging camera
201-1 to 201-N Object recognition unit
202 3D shape data generation unit
203 Part position estimation unit
204 Interpolation unit
205 Texture generation unit

1. An information processing device comprising:
a 3D shape data generation unit configured to generate 3D shape data representing a 3D shape of a modeling target, which is a target for generating a 3D model, on a basis of a plurality of captured images obtained by capturing the modeling target from different viewpoint positions; and
an interpolation unit configured to interpolate 3D shape data of a missing section of the modeling target, the missing section being missing in 3D shape data generated by the 3D shape data generation unit.

2. The information processing device according to claim 1, wherein the 3D shape data generation unit generates the 3D shape data on a basis of an image region of the modeling target in each of the plurality of captured images.

3. The information processing device according to claim 2, wherein the 3D shape data generation unit generates the 3D shape data using a visual-volume intersection method.

4. The information processing device according to claim 2, further comprising
an image recognition unit configured to recognize the modeling target in each of the plurality of captured images and detect the image region of the modeling target that has been recognized.

5. The information processing device according to claim 4, wherein the image recognition unit recognizes the modeling target by an inference model having a structure of a neural network generated by machine learning.

6. The information processing device according to claim 1, wherein the interpolation unit specifies a three-dimensional region in which the missing section should originally exist on a basis of a three-dimensional position of a predetermined portion of the modeling target estimated by a position of a predetermined portion of the modeling target in each of the plurality of captured images, and adds 3D shape data of the missing section to the three-dimensional region that has been specified.

7. The information processing device according to claim 6, further comprising
a position estimation unit configured to estimate the three-dimensional position of the predetermined portion on a basis of a position of the predetermined portion of the modeling target in each of the plurality of captured images.

8. The information processing device according to claim 7, wherein the position estimation unit calculates a plurality of three-dimensional positions as the three-dimensional position of the predetermined portion on a basis of a position of the predetermined portion of the modeling target in each of the plurality of captured images, and estimates the three-dimensional position of the predetermined portion on a basis of the plurality of three-dimensional positions that have been calculated.

9. The information processing device according to claim 8, wherein the position estimation unit estimates a barycentric position of the plurality of the three-dimensional positions that have been calculated, as the three-dimensional position of the predetermined portion.

10. The information processing device according to claim 6, wherein the predetermined portion of the modeling target is a portion included in the missing section.

11. The information processing device according to claim 1, further comprising
a texture generation unit configured to generate a texture to be pasted to the 3D shape data on a basis of an image of the modeling target in each of the plurality of captured images.

12. The information processing device according to claim 1, wherein any one or more of the plurality of captured images are captured images captured by a rolling shutter type.

13. The information processing device according to claim 1, wherein the modeling target includes a plurality of types of objects.

14. The information processing device according to claim 1, wherein the modeling target includes a person.

15. The information processing device according to claim 1, wherein the modeling target includes a tool used by a person.

16. An information processing method performed by an information processing device including
a 3D shape data generation unit and an interpolation unit,
the method comprising:
generating, by the 3D shape data generation unit, 3D shape data representing a 3D shape of a modeling target, which is a target for generating a 3D model, on a basis of a plurality of captured images obtained by capturing the modeling target from different viewpoint positions; and
interpolating, by the interpolation unit, 3D shape data of a missing section of the modeling target, the missing section being missing in the 3D shape data.

17. A program causing a computer to function as:
a 3D shape data generation unit configured to generate 3D shape data representing a 3D shape of a modeling target, which is a target for generating a 3D model, on a basis of a plurality of captured images obtained by capturing the modeling target from different viewpoint positions; and
an interpolation unit configured to interpolate 3D shape data of a missing section of the modeling target, the missing section being missing in 3D shape data generated by the 3D shape data generation unit.
